(19) United States
(12) Patent Application Publication
(10) Pub. No.: US 2026/0259294 A1
(43) Pub. Date: Sep. 3, 2026

(54) POSITIONING METHOD, TERMINAL DEVICE, AND NETWORK DEVICE

(71) Applicant: Quectel Wireless Solutions Co., Ltd., Shanghai (CN)

(72) Inventor: Zheng ZHAO, Shanghai (CN)

(73) Assignee: Quectel Wireless Solutions Co., Ltd., Shanghai (CN)

(21) Appl. No.: 19/657,500

(22) Filed: Apr. 24, 2026

Related U.S. Application Data
(63) Continuation of application No. PCT/CN2024/082410, filed on Mar. 19, 2024.

(51) Int. Cl. G01S 5/02; G01S 5/14

(52) U.S. Cl. CPC G01S 5/0273; G01S 5/145

(57) ABSTRACT

A positioning method includes: transmitting, by a terminal device, first information to a first network device, where the first information is used to indicate a Non-Line-of-Sight (NLOS) channel deviation at a location of the terminal device. The first information is carried in a Line-of-Sight (LOS) indication or an NLOS indication. The first information indicates a mean and/or a variance of the NLOS channel deviation.

### CROSS-REFERENCE TO RELATED APPLICATIONS

This application is a continuation of International Application No. PCT/CN2024/082410, filed on Mar. 19, 2024, the content of which is incorporated herein by reference in its entirety.

### TECHNICAL FIELD

This application relates to the field of communication technologies, and more specifically, to a positioning method, a terminal device, and a network device.

### BACKGROUND

The position of a terminal device is typically determined based on a distance between the terminal device and a network device. In related technologies, the distance between the terminal device and the network device is usually assumed to be a Line-of-Sight (LOS or LoS) path. However, in most terrestrial wireless signal propagation environments, particularly in indoor or urban scenarios, an LOS path does not always exist between the terminal device and the network device, leading to positioning errors for the terminal device.

### SUMMARY

An embodiment of the present invention provides an apparatus for transmitting data, where the apparatus includes:

This application provides a positioning method, a terminal device, and a network device. The following describes various aspects of the application.

A first aspect provides a positioning method, including: transmitting, by a terminal device, first information to a first network device, where the first information indicates a Non-Line-of-Sight (NLOS) channel deviation at a location of the terminal device.

In some embodiments, the first information is carried in a Line-of-Sight (LOS) indication or an NLOS indication.

In some embodiments, the first information indicates a mean and/or a variance of the NLOS channel deviation.

In some embodiments, the first information is determined based on one or more of the following: a pseudorange between the terminal device and a second network device; an estimated position of the terminal device; or an estimated clock error of the terminal device.

In some embodiments, the estimated position of the terminal device and/or the estimated clock error of the terminal device are determined using a maximum likelihood estimation algorithm based on the pseudorange between the terminal device and the second network device.

In some embodiments, the estimated position of the terminal device and the estimated clock error of the terminal device are calculated using the following formula:

$${( \hat{x} , \hat{τ} )}_{MLE} = arg {max}_{x , τ} p ( ρ \vert x , τ ) ,$$

where ρ denotes the pseudorange between the terminal device and the second network device, \hat{x} denotes the estimated position of the terminal device, \hat{τ} denotes the estimated clock error of the terminal device, x denotes position coordinates of the terminal device to be solved, τ denotes a clock error of the terminal device to be solved.

In some embodiments, a quantity of the second network device is B, the pseudorange between the terminal device and the second network device includes pseudoranges between the terminal device and respective ones of the B second network devices, and the first information includes means of NLOS channel deviations for the respective ones of the B second network devices.

In some embodiments, a NLOS channel deviation γ_{b} for a second network device b among the B second network devices is calculated using the following formula: γ_{b}=ρ_{b}−∥\hat{x}-x_{b}∥−\hat{τ}, where ρ_{b} denotes the pseudorange between the second network device b and the terminal device, x_{b} denotes a position of the second network device b, the second network device b is one of the B second network devices and b∈{1, . . . , B}.

In some embodiments, a plurality of values of γ_{b} are used to update a mean μ_{b} and/or a variance

$${\tilde{σ}}_{b}^{2}$$

of the NLOS channel deviation for the second network device b by applying a Gaussian Mixture Model.

In some embodiments, a formula for calculating the estimated position of the terminal device and the estimated clock error of the terminal device is determined based on means of NLOS channel deviations for the respective ones of the B second network devices, an expanded solution formula of

$${( \hat{x} , \hat{τ} )}_{MLE} = arg {max}_{x , τ} p ( ρ \vert x , τ )$$

is as follows:

$$( \hat{x} , \hat{τ} ) = arg {max}_{x , τ} {\prod }_{b = 1}^{B} \frac{1}{\sqrt{2 {πσ}_{b}^{′2}}} exp [ \frac{- 1}{2 {σ}_{b}^{′2}} {( {ρ}_{b} - ‖ x - {x}_{b} ‖ - τ - {μ}_{b} )}^{2} ] , where$$

$${σ}_{b}^{′2} = {\tilde{σ}}_{b}^{2} + {σ}_{b}^{2} , and {σ}_{b}^{2}$$

denotes a variance of a random variable.

In some embodiments, the expanded solution formula of

$${( \hat{x} , \hat{τ} )}_{MLE} = arg {max}_{x , τ} p ( ρ \vert x , τ )$$

is derived based on: a conditional likelihood function of ρ_{b} and a Gaussian probability distribution of γ_{b} where the conditional likelihood function of ρ_{b} is:

$$p ( {ρ}_{b} \vert x , τ , {γ}_{b} ) = \frac{1}{\sqrt{2 π} {σ}_{b}} exp [ \frac{- 1}{2 {σ}_{b}^{2}} {( {ρ}_{b} - ‖ x - {x}_{b} ‖ - τ - {γ}_{b} )}^{2} ] ,$$

the Guassian probability distribution of γ_{b} is:

$$p ( {γ}_{b} ) = \frac{1}{{\tilde{σ}}_{b} \sqrt{2 π}} exp [ \frac{- 1}{2 {\tilde{σ}}_{b}^{2}} {( {γ}_{b} - {μ}_{b} )}^{2} ] .$$

A second aspect provides a positioning method, including: receiving, by a first network device, first information transmitted by a terminal device, where the first information indicates a Non-Line-of-Sight (NLOS) channel deviation at the location of the terminal device.

In some embodiments, the first information is carried in a Line-of-Sight (LOS) indication or an NLOS indication.

In some embodiments, the first information indicates a mean and/or a variance of the NLOS channel deviation.

In some embodiments, the first information is determined based on one or more of the following: a pseudorange between the terminal device and a second network device; an estimated position of the terminal device; or an estimated clock error of the terminal device.

In some embodiments, the estimated position of the terminal device and/or the estimated clock error of the terminal device are determined using a maximum likelihood estimation algorithm based on the pseudorange between the terminal device and the second network device.

In some embodiments, the estimated position of the terminal device and the estimated clock error of the terminal device are calculated using the following formula:

$${( \hat{x} , \hat{τ} )}_{MLE} = arg {max}_{x , τ} p ( ρ \vert x , τ ) ,$$

where ρ denotes the pseudorange between the terminal device and the second network device, \hat{x} denotes the estimated position of the terminal device, \hat{τ} denotes the estimated clock error of the terminal device, x denotes position coordinates of the terminal device to be solved, τ denotes a clock error of the terminal device to be solved.

In some embodiments, a quantity of the second network device is B, the pseudorange between the terminal device and the second network device includes pseudoranges between the terminal device and respective ones of the B second network devices, and the first information includes means of NLOS channel deviations for the respective ones of the B second network devices.

In some embodiments, a NLOS channel deviation γ_{b} for a second network device b among the B second network devices is calculated using the following formula: γ_{b}=ρ_{b}−∥\hat{x}−x_{b}∥−\hat{τ}, where ρ_{b} denotes the pseudorange between the second network device b and the terminal device, x_{b} denotes a position of the second network device b, the second network device b is one of the B second network devices and b∈{1, . . . , B}.

In some embodiments, a plurality of values of Y are used to update a mean μ_{b} and/or a variance

$${\tilde{σ}}_{b}^{2}$$

of the NLOS channel deviation for the second network device b by applying a Gaussian Mixture Model.

In some embodiments, a formula for calculating the estimated position of the terminal device and the estimated clock error of the terminal device is determined based on means of NLOS channel deviations for the respective ones of the B second network devices, the expanded solution formula of

$${( \hat{x} , \hat{τ} )}_{MLE} = arg {max}_{x , τ} p ( ρ \vert x , τ )$$

is as follows:

$$( \hat{x} , \hat{τ} ) = arg {max}_{x , τ} {\prod }_{b = 1}^{B} \frac{1}{\sqrt{2 {πσ}_{b}^{′2}}} exp [ \frac{- 1}{2 {σ}_{b}^{′2}} {( {ρ}_{b} - ‖ x - {x}_{b} ‖ - τ - {μ}_{b} )}^{2} ] , where$$

$${σ}_{b}^{′2} = {\tilde{σ}}_{b}^{2} + {σ}_{b}^{2} , and {σ}_{b}^{2}$$

denotes a variance of a random variable.

In some embodiments, the expanded solution formula of

$${( \hat{x} , \hat{τ} )}_{MLE} = arg {max}_{x , τ} p ( ρ \vert x , τ )$$

is derived based on a conditional likelihood function of ρ_{b} and a Gaussian probability distribution of γ_{b}, where the conditional likelihood function of ρ_{b} is:

$$p ( {ρ}_{b} \vert x , τ , {γ}_{b} ) = \frac{1}{\sqrt{2 π} {σ}_{b}} exp [ \frac{- 1}{2 {σ}_{b}^{2}} {( {ρ}_{b} - ‖ x - {x}_{b} ‖ - τ - {γ}_{b} )}^{2} ] ,$$

the Gaussian probability distribution of γ_{b} is:

$$p ( {γ}_{b} ) = \frac{1}{{\tilde{σ}}_{b} \sqrt{2 π}} exp [ \frac{- 1}{2 {\tilde{σ}}_{b}^{2}} {( {γ}_{b} - {μ}_{b} )}^{2} ] .$$

A third aspect provides a terminal device, including: a transmission unit, configured to transmit first information to a first network device, where the first information indicates a Non-Line-of-Sight (NLOS) channel deviation at the location of the terminal device.

In some embodiments, the first information is carried in a Line-of-Sight (LOS) indication or an NLOS indication.

In some embodiments, the first information indicates a mean and/or a variance of the NLOS channel deviation.

In some embodiments, the first information is determined based on one or more of the following: a pseudorange between the terminal device and a second network device; an estimated position of the terminal device; or an estimated clock error of the terminal device.

In some embodiments, the estimated position of the terminal device and/or the estimated clock error of the terminal device are determined using a maximum likelihood estimation algorithm based on the pseudorange between the terminal device and the second network device.

In some embodiments, the estimated position of the terminal device and the estimated clock error of the terminal device are calculated using the following formula

$${( \hat{x} , \hat{τ} )}_{MLE} = arg {max}_{x , τ} p ( ρ \vert x , τ ) ,$$

where ρ denotes the pseudorange between the terminal device and the second network device, \hat{x} denotes the estimated position of the terminal device, \hat{τ} denotes the estimated clock error of the terminal device, x denotes position coordinates of the terminal device to be solved, τ denotes a clock error of the terminal device to be solved.

In some embodiments, a quantity of the second network device is B, the pseudorange between the terminal device and the second network device includes pseudoranges between the terminal device and respective ones of the B second network devices, and the first information includes means of NLOS channel deviations for the respective ones of the B second network devices.

In some embodiments, a NLOS channel deviation γ_{b} for a second network device b among the B second network devices is calculated using the following formula: γ_{b}=ρ_{b}−∥\hat{x}−x_{b}∥−\hat{τ}, where ρ_{b} denotes the pseudorange between the second network device b and the terminal device, x_{b} denotes a position of the second network device b, the second network device b is one of the B second network devices and b∈{1, . . . , B}.

In some embodiments, a plurality of values of γ_{b} are used to update a mean 14 and/or a variance

$${\tilde{σ}}_{b}^{2}$$

of the NLOS channel deviation for the second network device b by applying a Gaussian Mixture Model.

In some embodiments, a formula for calculating the estimated position of the terminal device and the estimated clock error of the terminal device is determined based on means of NLOS channel deviations for the respective ones of the B second network devices, the expanded solution formula of

$${( \hat{x} , \hat{τ} )}_{MLE} = arg {max}_{x , τ} p ( ρ \vert x , τ )$$

is as follows:

$$( \hat{x} , \tilde{τ} ) = arg {max}_{x , τ} {\prod }_{b = 1}^{B} \frac{1}{\sqrt{2 {πσ}_{b}^{′2}}} exp ⌋ \frac{- 1}{2 {σ}_{b}^{′2}} {( {ρ}_{b} - ‖ x - {x}_{b} ‖ - τ - {μ}_{b} )}^{2} , where$$

$${σ}_{b}^{′2} = {\tilde{σ}}_{b}^{2} + {σ}_{b}^{2} , and {σ}_{b}^{2}$$

denotes a variance of a random variable.

In some embodiments, the expanded solution formula of

$${( \hat{x} , \hat{τ} )}_{MLE} = arg {max}_{x , τ} p ( ρ \vert x , τ )$$

is derived based on a conditional likelihood function of ρ_{b} and a Gaussian probability distribution of γ_{b}, where the conditional likelihood function of ρ_{b} is:

$$p ( {ρ}_{b} \vert x , τ , {γ}_{b} ) = \frac{1}{\sqrt{2 π} {σ}_{b}} exp [ \frac{- 1}{2 {σ}_{b}^{2}} {( {ρ}_{b} - ‖ x - {x}_{b} ‖ - τ - {γ}_{b} )}^{2} ] ,$$

the Gaussian probability distribution of γ_{b} is:

$$p ( {γ}_{b} ) = \frac{1}{{\tilde{σ}}_{b} \sqrt{2 π}} exp [ \frac{- 1}{2 {\tilde{σ}}_{b}^{2}} {( {γ}_{b} - {μ}_{b} )}^{2} ] .$$

A fourth aspect provides a network device, where the network device is a first network device, and the network device includes: a receiving unit, configured to receive first information transmitted by a terminal device, and the first information indicates a Non-Line-of-Sight (NLOS) channel deviation at a location of the terminal device.

In some embodiments, the first information is carried in a Line-of-Sight (LOS) indication or an NLOS indication.

In some embodiments, the first information indicates a mean and/or a variance of the NLOS channel deviation.

In some embodiments, the first information is determined based on one or more of the following: a pseudorange between the terminal device and a second network device; an estimated position of the terminal device; an estimated clock error of the terminal device.

In some embodiments, the estimated position of the terminal device and/or the estimated clock error of the terminal device are determined using a maximum likelihood estimation algorithm based on the pseudorange between the terminal device and the second network device.

In some embodiments, the estimated position of the terminal device and the estimated clock error of the terminal device are calculated using the following formula

$${( \hat{x} , \hat{τ} )}_{MLE} = arg {max}_{x , τ} p ( ρ \vert x , τ ) ,$$

where ρ denotes the pseudorange between the terminal device and the second network device, \hat{x} denotes the estimated position of the terminal device, \hat{τ} denotes the estimated clock error of the terminal device, x denotes position coordinates of the terminal device to be solved, τ denotes a clock error of the terminal device to be solved.

In some embodiments, a quantity of the second network device is B, the pseudorange between the terminal device and the second network device includes pseudoranges between the terminal device and respective ones of the B second network devices, and the first information includes means of NLOS channel deviations for the respective ones of the B second network devices.

In some embodiments, a NLOS channel deviation γ_{b} for a second network device b among the B second network devices is calculated using the following formula: γ_{b}=ρ_{b}−∥\hat{x}−x_{b}∥−\hat{τ}, where ρ_{b} denotes the pseudorange between the second network device b and the terminal device, x_{b} denotes a position of the second network device b, the second network device b is one of the B second network devices and b∈{1, . . . , B}.

In some embodiments, a plurality of values of γ_{b} are used to update a mean 14 and/or a variance

$${\tilde{σ}}_{b}^{2}$$

of the NLOS channel deviation for the second network device b by applying a Gaussian Mixture Model.

In some embodiments, a formula for calculating the estimated position of the terminal device and the estimated clock error of the terminal device is determined based on means of NLOS channel deviations for the respective ones of the B second network devices, the expanded solution formula of

$${( \hat{x} , \hat{τ} )}_{MLE} = arg {max}_{x , τ} p ( ρ \vert x , τ )$$

is as follows:

$$( \hat{x} , \hat{τ} ) = arg {max {\prod }_{b = 1}^{B}}_{x , τ} \frac{1}{\sqrt{2 {πσ}_{b}^{′2}}} exp [ \frac{- 1}{2 {σ}_{b}^{′2}} {( {ρ}_{b} - ‖ x - {x}_{b} ‖ - τ - {μ}_{b} )}^{2} ] , where$$

$${σ}_{b}^{′2} = {\tilde{σ}}_{b}^{2} + {σ}_{b}^{2} , and {σ}_{b}^{2}$$

denotes a variance of a random variable.

In some embodiments, the expanded solution formula of

$${( \hat{x} , \hat{τ} )}_{MLE} = arg {max}_{x , τ} p ( ρ \vert x , τ )$$

is derived based on a conditional likelihood function of ρ_{b} and a Gaussian probability distribution of γ_{b} where the conditional likelihood function of ρ_{b} is:

$$p ( {ρ}_{b} \vert x , τ , {γ}_{b} ) = \frac{1}{\sqrt{2 π} {σ}_{b}} exp [ \frac{- 1}{2 {σ}_{b}^{2}} {( {ρ}_{b} - ‖ x - {x}_{b} ‖ - τ - {γ}_{b} )}^{2} ] ,$$

the Gaussian probability distribution of γ_{b} is:

$$p ( {γ}_{b} ) = \frac{1}{{\tilde{σ}}_{b} \sqrt{2 π}} exp [ \frac{- 1}{2 {\tilde{σ}}_{b}^{2}} {( {γ}_{b} - {μ}_{b} )}^{2} ] .$$

A fifth aspect provides a terminal device, including a processor and a memory, where the memory is configured to store one or more computer programs, and the processor is configured to invoke the computer programs in the memory to cause the terminal device to perform part or all of the steps in the method according to the first aspect.

A sixth aspect provides a network device including a processor, a memory, and a transceiver, where the memory is configured to store one or more computer programs, and the processor is configured to invoke the computer programs in the memory to cause the network device to perform part or all of the steps in the method according to the second aspect.

In a seventh aspect, an embodiment of the present application provides a device, including a memory and a processor, where the processor is configured to invoke and execute computer programs from the memory to perform part or all of the steps described in the methods according to the foregoing various aspects.

In an eighth aspect, an embodiment of the present application provides a computer-readable storage medium, where the computer-readable storage medium stores a computer program, and the computer program causes a terminal device and/or a network device to perform part or all of the steps in the methods according to the foregoing various aspects.

In a ninth aspect, an embodiment of the present application provides a computer program product, where the computer program product includes a non-transitory computer-readable storage medium storing a computer program, and the computer program is operable to cause a terminal device and/or a network device to perform part or all of the steps in the methods according to the foregoing various aspects. In some implementations, the computer program product may be a software installation package.

In a tenth aspect, an embodiment of the present application provides a chip, including a memory and a processor, where the processor is configured to invoke and execute computer programs from the memory to perform part or all of the steps described in the methods according to the foregoing various aspects.

### BRIEF DESCRIPTION OF THE DRAWINGS

FIG. 1 is a schematic diagram of a wireless communication system to which embodiments of the present application are applied.

FIG. 2 shows an example diagram of line-of-sight and non-line-of-sight in an application scenario.

FIG. 3 is a schematic flowchart of a positioning method provided by an embodiment of the present application.

FIG. 4 is a schematic diagram illustrating the principle of an unsupervised learning statistical method provided by an embodiment of the present application.

FIG. 5 is a schematic structural diagram of a terminal device provided by an embodiment of the present application.

FIG. 6 is a schematic structural diagram of a network device provided by an embodiment of the present application.

FIG. 7 is a schematic structural diagram of a device provided by an embodiment of the present application.

### DETAILED DESCRIPTION OF THE EMBODIMENTS

The technical solutions in this application will be described below with reference to the accompanying drawings.

### Communication System

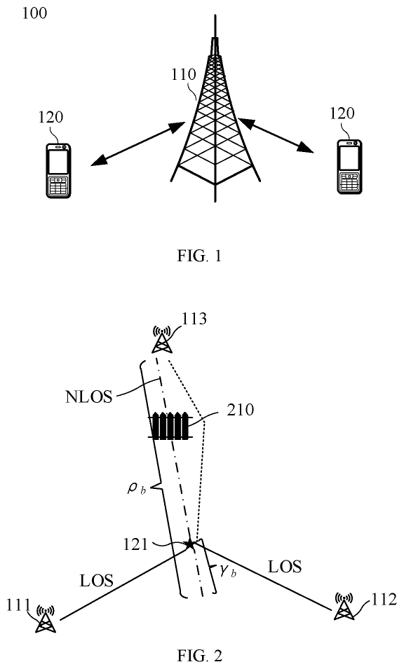

FIG. 1 shows a wireless communication system 100 to which embodiments of this application are applied. The wireless communication system 100 may include a network device 110 and a terminal device 120. The network device 110 may be a device that communicates with the terminal device 120. The network device 110 may provide communication coverage for a specific geographic area and may communicate with the terminal device 120 located within the coverage area.

FIG. 1 exemplarily shows one network device and two terminal devices. Optionally, the wireless communication system 100 may include multiple network devices, and the coverage area of each network device may include other numbers of terminal devices, which is not limited in the embodiments of this application.

Optionally, the wireless communication system 100 may further include other network entities such as a network controller and a mobility management entity, which is not limited in the embodiments of this application.

It should be understood that the technical solutions of the embodiments of this application may be applied to various communication systems, for example: a fifth generation (5G) system or a new radio (NR) system, a long term evolution (LTE) system, an LTE frequency division duplex (FDD) system, an LTE time division duplex (TDD) system, and the like. The technical solutions provided in this application may also be applied to future communication systems, such as a sixth generation mobile communication system, a satellite communication system, and the like.

The terminal device in the embodiments of this application may also be referred to as user equipment (UE), an access terminal, a subscriber unit, a subscriber station, a mobile station (MS), a mobile terminal (MT), a remote station, a remote terminal, a mobile device, a user terminal, a terminal, a wireless communication device, a user agent, or a user device. The terminal device in the embodiments of this application may be a device that provides voice and/or data connectivity to a user, and may be used to connect people, things, and machines, for example, a handheld device with a wireless connection function, an in-vehicle device, and the like. The terminal device in the embodiments of this application may be a mobile phone, a tablet computer (Pad), a laptop computer, a palmtop computer, a mobile internet device (MID), a wearable device, a virtual reality (VR) device, an augmented reality (AR) device, a wireless terminal in industrial control, a wireless terminal in self-driving, a wireless terminal in remote medical surgery, a wireless terminal in a smart grid, a wireless terminal in transportation safety, a wireless terminal in a smart city, a wireless terminal in a smart home, and the like. Optionally, the UE may be used to act as a base station. For example, the UE may act as a scheduling entity that provides a sidelink signal between UEs in vehicle-to-everything (V2X) or device-to-device (D2D) communication. For example, a cellular phone and a car communicate with each other using a sidelink signal. A cellular phone and a smart home device communicate without relaying communication signals through a base station.

The network device in the embodiments of this application may be a device used for communicating with a terminal device. The network device may also include an access network device. The access network device may also be referred to as a radio access network device, a base station, or the like. The access network device in the embodiments of this application may be a radio access network (RAN) node (or device) that connects the terminal device to a wireless network. The access network device may generally cover various names listed below or may be replaced with the following names, for example: a base station (BS), a NodeB, an evolved NodeB (eNB), a next generation NodeB (gNB), a relay station, an access point, a transmitting and receiving point (TRP), a transmitting point (TP), a master eNB (MeNB), a secondary eNB (SeNB), a multi-standard radio (MSR) node, a home base station, a network controller, an access node, a wireless node, an access point (AP), a transmission node, a transceiver node, a baseband unit (BBU), a remote radio unit (RRU), an active antenna unit (AAU), a remote radio head (RRH), a central unit (CU), a distributed unit (DU), a positioning node, and the like. The base station may be a macro base station, a micro base station, a relay node, a donor node, or the like, or a combination thereof. The base station may also refer to a communication module, a modem, or a chip disposed in the foregoing device or apparatus. The base station may also be a mobile switching center and a device that performs a base station function in D2D, V2X, machine-to-machine (M2M) communication, a network-side device in a 6G network, a device that performs a base station function in a future communication system, and the like. The base station may support networks using the same or different access technologies. The embodiments of this application do not limit the specific technology and the specific device form used by the access network device.

The base station may be fixed or mobile. For example, a helicopter or a drone may be configured to act as a mobile base station, and one or more cells may move according to a location of the mobile base station. In other examples, a helicopter or a drone may be configured to act as a device that communicates with another base station.

In some deployments, the network device in the embodiments of this application may refer to a CU or a DU, or the network device includes a CU and a DU. A gNB may further include an AAU.

The network device and the terminal device may be deployed on land (including indoor or outdoor, handheld or vehicle-mounted), on water surfaces, or on airborne platforms such as aircraft, balloons, and satellites. The embodiments of this application do not limit the deployment scenarios of the network device and the terminal device.

The communication devices involved in the wireless communication system may not only include access network devices and terminal devices but may also include core network devices. The core network device may also be a type of network device.

The core network device in the embodiments of this application may include devices that process and forward user signaling and data. For example, the core network device may include a Core Access and Mobility Management Function (AMF), a Session Management Function (SMF), a user plane gateway, a positioning server, and other core network devices. Among them, the user plane gateway may be a server with functions such as mobility management, routing, and forwarding of user plane data, typically located on the network side, such as a Serving Gateway (SGW), a Packet Data Network Gateway (PGW), or a User Plane Function (UPF). The AMF and SMF may correspond to the Mobility Management Entity (MME) in LTE systems. The AMF is primarily responsible for access control, while the SMF is mainly responsible for session management. Of course, the core network may also include other network elements, which are not exhaustively listed here.

The positioning server has positioning capabilities. The positioning server involved in the embodiments of this application may include: a Location Management Function (LMF), a Location Management Component (LMC), or a Local Location Management Function (LLMF) located in a network device. The embodiments of this application do not impose limitations on this. In some embodiments, the positioning server may also be referred to as a positioning management device.

It should be understood that all or part of the functions of the communication devices in this application may also be implemented through software running on hardware or through virtualized functions instantiated on a platform (e.g., a cloud platform).

### Positioning Technology

With the rise of intelligence, positioning requirements in various industries have become increasingly urgent. Traditional positioning systems such as the Global Navigation Satellite System (GNSS) and Ultra-Wide Band (UWB) are limited by coverage range and cannot be widely applied indoors. With advancements in communication technology, 5G, due to its advantages of high bandwidth, low latency, and massive connectivity, facilitates infrastructure upgrades, driving the society into the intelligent era. As global 5G deployment and vertical applications flourish, the industry urgently demands high-precision 5G positioning and 5G-integrated positioning technologies.

During the evolution of communication technologies, the 3rd Generation Partnership Project (3GPP) introduced 5G positioning. For example, the 3GPP Release 16 (Rel-16), finalized in June 2020, incorporated 5G base station (BS) positioning capabilities. Rel-16 is aimed for: indoor horizontal/vertical positioning accuracy less than 3 meters (80% of users are in the area) and end-to-end latency less than 1 second. Subsequently, 3GPP in 5G-Advanced project proposed continuous enhancements to positioning capabilities to enable emerging applications like the Internet of Things (IoT) and smart cities, while extending to public safety and other fields to deliver seamless positioning services. Currently, positioning scenarios fall into two broad categories: wide-area positioning scenarios and local-area positioning scenarios. The positioning is urgently required in local-area scenarios, especially localized positioning scenarios. The most typical applications include personnel, vehicle, equipment, and facility management.

In wireless positioning systems, the location of a mobile terminal device can be estimated by mapping signal characteristics to spatial coordinates. Positioning methods may, for example, rely on ranging-based techniques.

For ranging-based positioning, the distance from a terminal device to at least three network devices can be used to construct geometric shapes (e.g., circles or hyperbolas). Further, by calculating the intersections of these geometric shapes, the positioning result can be obtained. Time of Arrival (TOA) and Time Difference of Arrival (TDOA) are commonly used signal characteristics in ranging-based positioning methods. Ranging-based positioning methods relying on a Received Signal Strength (RSS) require fitting a path loss model.

In related technologies, the distance from a terminal device (or mobile node) to each of at least three network devices (or reference nodes) is typically determined based on a Line-of-Sight (LOS or LoS) path. LOS may refer to a scenario where the terminal device to be located and a network device can visually observe each other, directly visually or with visual aids. Generally, LOS implies that there are no obstacles between the terminal device and the network device. In an LOS path, the straight-line distance between the terminal device and the network device can be determined by multiplying the speed of light by a transmission time of the signal from the terminal device to the network device.

However, in most terrestrial wireless signal propagation environments, especially in indoor or urban scenarios, Non-Line-of-Sight (NLOS or NLoS) paths may exist between the terminal device and network devices. In other words, an LOS path does not always exist between the terminal device and the network devices. NLOS may refer to a scenario where the terminal device to be located and a network device cannot visually observe each other, directly visually or with visual aids. Typically, NLOS implies a presence of obstacles between the terminal device and the one network device. Since NLOS paths between terminal devices and network devices are not considered, the distances determined in related technologies may contain errors, leading to inaccuracies in the final determined position of the terminal device.

For ease of understanding, the positioning method of terminal devices in related technologies is schematically described below with reference to FIG. 2. In FIG. 2, the terminal device 121 is the terminal device to be positioned. The terminal device 121 can receive positioning reference signals from the network device 111, the network device 112, and the network device 113, respectively, to determine a distance ρ1 between the terminal device 121 and the network device 111, a distance ρ2 between the terminal device 121 and the network device 112, and a distance ρ3 between the terminal device 121 and the network device 113. It should be noted that the number of network devices shown in FIG. 2 is merely an example. In actual positioning scenarios, the number of network devices transmitting positioning reference signals may be B, where B is greater than or equal to 3. In some embodiments, the network devices transmitting positioning reference signals may be referred to as second network devices. The network devices transmitting positioning reference signals may be base stations with known locations, that is, the second network devices may be base stations, and the locations of these base stations are known. As shown in FIG. 2, there are no obstacles on the transmission path between the terminal device 121 and the network device 111 or between the terminal device 121 and the network device 112, whereas there is an obstacle 210 on the transmission path between the terminal device 121 and the network device 113. This obstacle may be any object that affects signal transmission. Therefore, the paths between the network device 111 and the terminal device 121 and between the network device 112 and the terminal device 121 are line-of-sight (LOS) paths, as indicated by solid lines. The path between the network device 113 and the terminal device 121 is a non-line-of-sight (NLOS) path, as indicated by a dashed line.

From FIG. 2, it can be observed that under the NLOS path, an actual transmission path of the signal between the network device 113 and the terminal device 121 is a polyline. In this case, if the distance between the network device 113 and the terminal device 121 is still determined using the method in related technologies (i.e., the speed of light multiplied by the transmission time), the calculated distance ρ3 (as shown by the dotted line in FIG. 2) will be greater than the actual distance between the network device 113 and the terminal device 121. Consequently, this may lead to an error in determining the distance between the terminal device and the network device (this error may be referred to as an NLOS error). Furthermore, when using this distance to determine the position of the terminal device, it is prone to falling into a local optimum problem, resulting in inaccuracies in the determined position of the terminal device.

Currently, 3GPP is discussing 5G positioning standards, with one important application scenario being indoor factories. In indoor factory environments, severe NLOS (Non-Line-of-Sight) errors may exist. Due to the presence of NLOS errors, the positioning accuracy of terminal devices in related technologies is relatively low, making it difficult to meet the positioning accuracy requirements of current and future communication technologies for terminal devices.

To address the above issues, in the positioning method proposed in the embodiments of this application, a terminal device may transmit first information to a first network device, where the first information indicates the NLOS channel deviation at the location of the terminal device. In this way, the estimated position of the terminal device can be corrected based on the first information, thereby improving the positioning accuracy of the terminal device.

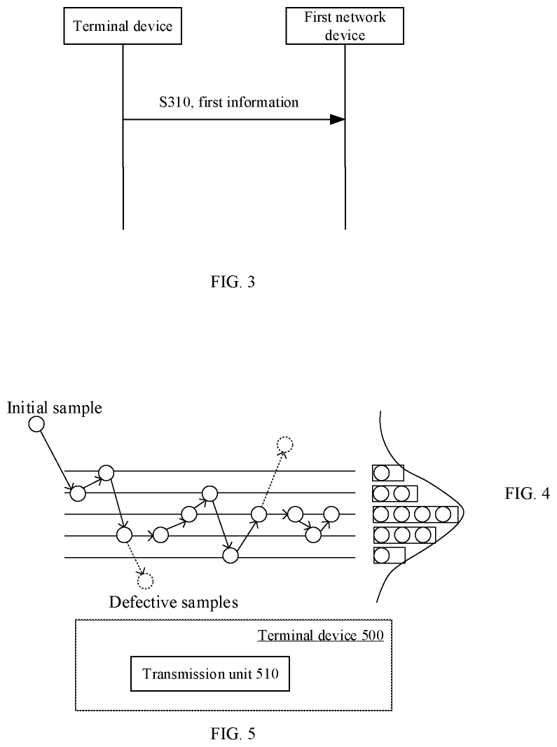

The positioning method in the embodiments of this application is described in detail below with reference to FIG. 3. As shown in FIG. 3, the positioning method 300 provided in the embodiments of this application may include step S310.

In step S310, the terminal device transmits the first information to the first network device.

The terminal device is the terminal device to be positioned. The embodiments of this application do not impose specific limitations on the type of the terminal device, which may be any of the terminal devices described earlier. In some embodiments, the terminal device is configured with a tag to communicate with the network device for positioning purposes.

In some embodiments, the first network device may be a serving base station that provides communication services to the terminal device. For example, the terminal device may receive messages from other terminal devices through the serving base station, or the terminal device may forward messages through the serving base station. The embodiments of this application do not impose specific limitations on the specific services provided by the serving base station. In some embodiments, the first network device may communicate with a positioning server to forward the first information transmitted by the terminal device to the positioning server.

As an example, the first network device may be any of the network devices in FIG. 2. That is, the first network device may be one of the multiple second network devices described earlier that provide positioning reference signals to the terminal device.

As another example, the first network device may be a network device independent of the multiple second network devices that transmit positioning reference signals. That is, the first network device does not transmit positioning reference signals to the terminal device but instead receives the first information transmitted by the terminal device.

In some other embodiments, the first network device may be a positioning server.

The first information indicates the Non-Line-of-Sight (NLOS) channel deviation at the position of the terminal device. The NLOS channel deviation at the position of the terminal device may also be referred to as NLOS error. By using the first information to indicate the NLOS channel deviation at the position of the terminal device, the position of the terminal device can be corrected based on the first information in subsequent precise positioning of the terminal device. For example, after receiving the first information, the first network device may correct the position of the terminal device accordingly.

In some embodiments, the first information is carried in a Line-of-Sight (LOS) indication or an NLOS indication. That is, the LOS/NLOS indication transmitted by the terminal device to the first network device contains the first information as a reporting parameter of the LOS/NLOS indication. The LOS/NLOS indication may refer to indication information that indicates the Line-of-Sight (LOS) type of a communication channel between the terminal device and the second network device. For instance, the LOS/NLOS indication may include: whether the distances between the terminal device and the second network devices measured by the terminal device contains a LOS or NLOS path; and/or, the probability that the distances between the terminal device and the second network devices measured by the terminal device includes a LOS or NLOS path.

As previously mentioned, the quantity of second network devices transmitting positioning reference signals to the terminal device is B (B≥3). The B second network devices may simultaneously transmit positioning reference signals and the B second network devices achieve time synchronization through GNSS (Global Navigation Satellite System). Accordingly, in some embodiments, the NLOS channel deviation at the position of the terminal device includes NLOS channel deviations for respectively ones of the B second network devices.

In some embodiments, the first information indicates a mean and/or a variance of the NLOS channel deviations. Accordingly, the first information includes means of NLOS channel deviations for the respective ones of the B second network devices.

In some implementations, the first information is determined based on one or more of the following: a pseudorange between the terminal device and the second network device; an estimated position of the terminal device; or an estimated clock error of the terminal device.

Here, the pseudorange between the terminal device and the second network device refers to a distance calculated by multiplying the speed of light by the transmission time of the positioning reference signal. As previously specified, since the quantity of second network devices transmitting positioning reference signals to the terminal device is B, the pseudorange between the terminal device and second network devices includes pseudoranges between the terminal device and respectively ones of the B second network devices.

Taking a second network device b among the B second network devices as an example, the pseudorange determination formula between the second network device b and the terminal device is: ρ_{b}=ct_{b}, where: ρ_{b} denotes the pseudorange from the second network device b to the terminal device; c denotes the speed of light; t_{b} denotes the estimated transmission time between the terminal device and the second network device b. Here, the second network device b is one of the B second network devices and b∈{1, . . . , B}.

If the path between the second network device b and the terminal device is a NLOS (Non-Line-of-Sight) path, as illustrated in FIG. 2, ρ_{b} will include an NLOS error (i.e., NLOS channel deviation γ_{b}, γ_{b} denotes the NLOS channel deviation for the second network device b and γ_{b}≥0, γ_{b} representing a random distance deviation in the NLOS channel). As one implementation approach, the determination formula for ρ_{b} can be expressed as Equation 1: ρ_{b}=ct_{b}=∥x−x_{b}∥+τ+γ_{b}+n_{b}.

Here, x denotes the position coordinates of the terminal device to be solved; τ denotes a clock error of the terminal device to be solved; x_{b} denotes a position of the second network device b; τ may be caused by synchronization mismatch between the terminal device and the second network device b; n_{b} is a random variable accounting for other pseudorange estimation errors. In some embodiments, n_{b} is a zero-mean Gaussian random variable with variance

$${σ}_{b}^{2} .$$

It should be noted that the position in the embodiments of this application is generally represented by coordinate values, which may be two-dimensional (2D) or three-dimensional (3D).

In Equation 1 above, if two-dimensional (2D) coordinates are used for positioning coordinates, at least three known second network devices positions x_{b} with their corresponding pseudoranges ρ_{b} are available. Based on this, the three unknown variables in Equation 1 can be solved base on the known information. For example, the positioning algorithm may estimate x and τ in Equation 1 to derive: the estimated position of the terminal device and the estimated clock error of the terminal device. That is: x=(x,y). \hat{x} denotes the estimated position of the terminal device; \hat{τ} denotes the estimated clock error of the terminal device.

In the embodiments of this application, the estimated position of the terminal device and/or the estimated clock error of the terminal device may be determined based on the pseudoranges between the terminal device and the respective second network devices using the Maximum Likelihood Estimation (MLE) algorithm. The MLE is recognized as being asymptotically unbiased and asymptotically achieving the Cramer-Rao Lower Bound (CRLB). Consequently, the MLE is asymptotically efficient and optimal. The CRLB serves as a tool for evaluating whether an unbiased estimator is effective. An estimator, when meeting this bound, is a Minimum Variance Unbiased Estimator (MVUE). An MVUE indicates that an estimated value is effective.

As an example, the formulas for determining both the estimated position of the terminal device and/or the estimated clock error of the terminal device are given by Equation 2:

$${( \hat{x} , \hat{τ} )}_{MLE} = arg {max}_{x , τ} p ( ρ \vert x , τ ) ,$$

where ρ denotes the pseudorange between the terminal device and the second network device, \hat{x} denotes the estimated position of the terminal device determined via the maximum likelihood estimation algorithm, \hat{τ} denotes the estimated clock error of the terminal device determined via the maximum likelihood estimation algorithm. As previously described, the quantity of the second network devices may be B. Thus, ρ can be interpreted as a set or a matrix including multiple ρ_{b}, that is, the pseudorange between the terminal device and the second network device includes pseudoranges between the terminal device and respective ones of the B second network devices, that is, ρ including multiple ρ_{b}, each two among the multiple ρ_{b} has different values of b.

With reference to FIG. 2 and the preceding description, the pseudorange ρ_{b} includes NLOS error γ_{b} and τ. When τ is known, γ_{b} can be estimated and eliminated in the MLE process. In some embodiments, γ_{b} is calculated using Equation 3: γ_{b}=ρ_{b}−∥\hat{x}−x_{b}∥−\hat{τ}, where ρ_{b} is the pseudorange between the second network device b and the terminal device; \hat{x} is the estimated position of the terminal device; x_{b} is a position of the second network device b; \hat{τ} is the estimated clock error of the terminal device, the second network device b is one of the B second network devices and b∈{1, 2, . . . , B}.

In some embodiments, when a NLOS path exists between the second network device b and the terminal device, the positioning reference signal in the wireless communication channel may arrive at the receiver (i.e., the terminal device) via multiple propagation paths due to reflection or scattering. Since each path may have a different time delay, multiple pseudorange ρ_{b}, may exist between the second network device b and the terminal device. These multiple pseudorange ρ_{b} may also be referred to as observed values. Consequently, γ_{b} corresponding to the second network device b may include multiple values.

In some embodiments, when sufficient scattering exists in the propagation environment, the positioning reference signal arrived at the receiver manifests as a superposition of numerous statistically independent random variables. According to the Central Limit Theorem, the impulse response of such a wireless channel follows a Gaussian process. Consequently, the multiple γ_{b} can be utilized to update the mean μ_{b} and/or the variance

$${\tilde{σ}}_{b}^{2}$$

of the NLOS channel deviation for the second network device b via a Gaussian Mixture Model (GMM). In other words, when multiple observed values exist, a GMM can be applied to update the mean μ_{b} of γ_{b} and/or the variance

$${\tilde{σ}}_{b}^{2}$$

of γ_{b}.

In some embodiments, the estimated position \hat{x} of the terminal device and/or the estimated clock error \hat{τ} of the terminal device may be determined through multiple iterations. For example, with a total of I iterations, each of the I iterations uses a similar method for determining the estimated position \hat{x} of the terminal device and/or the estimated clock error \hat{τ} of the terminal device, that is, the same calculation formula is applied to the processes of iterations, but with different initial values for each iteration. In this process, the initial values used for each iteration may be determined based on multiple ρ_{b} collected from each second network device at the current iteration time instant. In the next iteration time instant (i.e., in a tracking loop), an initial iteration position of the terminal device is updated using observed values (multiple ρ_{b} from each second network device) at the next time instant and a final position of the terminal device is recalculated through re-iteration. It should be noted that the initial iteration position may be determined according to Equation 2. The initial iteration position used in each iteration can be interpreted as the First Arrival Path (FAP).

As previously described, the determination formula for γ_{b} is γ_{b}=ρ_{b}−∥\hat{x}-x_{b}∥−\hat{τ}. When the estimated position \hat{x} of the terminal device and/or the estimated clock error \hat{τ} of the terminal device are determined through I iterations, the corresponding NLOS error between the second network device b and the terminal device in the i-th iteration among the I iterations can be denoted as γ_{i,b}, where γ_{i,b}=ρ_{b}−∥\hat{x}−x_{b}∥−\hat{τ}ᵢ, where \hat{x}ᵢ denotes the initial iteration position of the terminal device for the i-th iteration, \hat{τ}ᵢ denotes the initial value of the estimated clock error of the terminal device for the i-th iteration, that is, \hat{x}ᵢ and \hat{τ}ᵢ are hypothesis values determined according to Equation 2, and i denotes the iteration counter.

In some embodiments, the first information enables re-iteration to determine the estimated position of the terminal device (i.e., the final position of the terminal device) and the estimated clock error of the terminal device. As an example, during the process of re-iteration, the determination formula (Equation 2 mentioned earlier) for the estimated position of the terminal device and the estimated clock error of the terminal device is derived based on the mean of the NLOS channel deviations for respective ones of the B second network devices. The expanded solution formula of Equation 2 is Equation 4:

$$( \hat{x} , \hat{τ} ) = arg {max {\prod }_{b = 1}^{B}}_{x , τ} \frac{1}{\sqrt{2 {πσ}_{b}^{′2}}} exp [ \frac{- 1}{2 {σ}_{b}^{′2}} {( {ρ}_{b} - ‖ x - {x}_{b} ‖ - τ - {μ}_{b} )}^{2} ] , where$$

$${σ}_{b}^{′2} = {\tilde{σ}}_{b}^{2} + {σ}_{b}^{2} , and {σ}_{b}^{2}$$

is the variance of the random variable n_{b}.

In some embodiments, Equation 4 is derived based on a conditional likelihood function of ρ_{b} and a Gaussian probability distribution of γ_{b}. Given that n_{b} is a zero-mean Gaussian random variable with variance

$${σ}_{b}^{2} ,$$

the conditional likelihood function of ρ_{b} can be expressed as Equation 5:

$$p ( {ρ}_{b} \vert x , τ , {γ}_{b} ) = \frac{1}{\sqrt{2 π} {σ}_{b}} exp [ \frac{- 1}{2 {σ}_{b}^{2}} {( {ρ}_{b} - ‖ x - {x}_{b} ‖ - τ - {γ}_{b} )}^{2} ] .$$

Given that an impulse response of the wireless channel follows a Gaussian process, the Gaussian probability distribution of γ_{b} can be expressed as Equation 6:

$$p ( {γ}_{b} ) = \frac{1}{{\tilde{σ}}_{b} \sqrt{2 π}} exp [ \frac{- 1}{2 {\tilde{σ}}_{b}^{2}} {( {γ}_{b} - {μ}_{b} )}^{2} ] .$$

As an example, the derivation process for Equation 4 proceeds as follows.

First, the likelihood function of ρ_{b} is determined based on Equation 5 and Equation 6, the likelihood function of ρ_{b} can be expressed as Equation 7 as follows.

$$p ( {ρ}_{b} \vert x , τ ) = p ( {ρ}_{b} \vert x , τ , {γ}_{b} ) p ( {γ}_{b} ) = \frac{1}{\sqrt{2 {πσ}_{b}^{2}}} exp [ \frac{- 1}{2 {σ}_{b}^{2}} {( {ρ}_{b} - ‖ x - {x}_{b} ‖ - τ - {μ}_{b} )}^{2} ] .$$

Here, p(ρ_{b}|x, τ) denotes the likelihood function of Pp. As evidenced by Equation 7, the likelihood function of ρ_{b} is derived as the product of the conditional likelihood function of ρ_{b} and the Gaussian probability distribution of γ_{b}.

Secondly, since the pseudorange measurements are statistically independent, the joint likelihood distribution of ρ is the accumulation of marginal distributions. That is, the joint likelihood distribution of ρ can be expressed as Equation 8:

$$p ( ρ \vert x , τ ) = {\prod }_{b = 1}^{B} p ( {ρ}_{b} \vert x , τ ) ,$$

where p(ρ|x, τ) is the joint likelihood distribution of ρ.

By combining Equation 2, Equation 7, and Equation 8, the expanded form of Equation 2 can be derived as Equation 4.

In this context, \hat{x} and \hat{τ} in Equation 4 can be numerically solved using iterative methods. The embodiments of this application do not impose specific limitations on the type of the iterative method used. For instance, either the Newton-Raphson (N-R) iteration method or a blind learning algorithm may be employed for solving the equations. Preferably, a blind learning algorithm may be adopted to overcome a potential local optima issue that may arise with the Newton-Raphson method.

This application imposes no specific restrictions on the type of blind learning algorithm. As one implementation, the blind learning algorithm may be a Markov Chain Monte Carlo (MCMC) algorithm. In MCMC algorithms, Metropolis-Hastings (M-H) sampling and Gibbs sampling are two widely utilized approaches. M-H sampling is an unsupervised statistical method that progressively identifies an optimal solution of the objective function via Markov chains, according to current-state and next-state estimator values. The entire search process is illustrated in FIG. 4. For a current sample, a subsequent sample is probabilistically constructed through the Markov chain state transition matrix, which is iterated until the optimal state is achieved. M-H sampling initiates with an initial sample and progressively identifies an optimal solution by eliminating suboptimal samples through Markov chains.

In some embodiments, the Rel-18 (the first release of 5G-Advanced) open datasets may be utilized to study 5G positioning algorithms. With the maturation in massive multiple-input multiple-output (MIMO) antennas, intelligent surfaces, and other technologies, increased NLOS signals and virtual anchors are expected to enhance 5G positioning accuracy. Beyond high-precision positioning, Integrated Sensing and Communication (ISAC) is anticipated to become one of the key features of 6G. Consequently, the proposed algorithm has been validated using the Rel-18-oriented open datasets. Results demonstrate that the positioning method in this application meets existing standards while improving the accuracy compared with algorithms in existing technologies. Thus, embodiments of this application achieve meter-level positioning on the 3GPP 5G Rel-18 datasets, offering practical implementations for 5G-Advanced high-precision technology applications.

The positioning algorithm in this application employs Maximum Likelihood Estimation (MLE) to calculate the position of the terminal device, which estimates NLOS based on measured First Arrival Paths and calculates NLOS errors relative to base stations, without requiring LOS/NLOS discrimination for the First Arrival Path. By estimating and eliminating NLOS errors in positioning through the Markov Chain Monte Carlo algorithm, the algorithm addresses the accuracy degradation due to the multipath effect in 5G signals, significantly improving positioning precision.

For clarity, a specific embodiment is detailed below for further illustration. Note that the following example is only used to help understanding of this application and does not confine the scope of this application to the specific values or scenarios described. A person skilled in the art, based on the examples provided, can make various equivalent modifications or variations. Such modifications or variations also fall within the scope of the embodiments of this application.

The steps of the MLE-based positioning method provided in the embodiments of this application are as follows.
1. Initializing parameters x₀ and μ₀, and for each iteration from 0 to I, collecting N pseudorange measurements.

Here, x₀ and μ₀ are respectively an initial position of the terminal device for the first iteration and an initial clock error of the terminal device for the first iteration. In some embodiments, x₀ and μ₀ may be derived from Equation 2 as previously described. For the i-th iteration, the collected N pseudorange measurements are denoted as: ρ_{i,1}, . . . , ρ_{i,N}.
2. For the quantity of iterations I, the quantity of the second network devices B, the algorithm iteratively calculates the N NLOS deviations for the second network device b under the i-th iteration, where i=0 to I, b=1 to B.

For the i-th iteration, the N NLOS deviations for the second network device b can be represented as γ_{1,i,b}, . . . , γ_{N,i,b}. For the n-th NLOS deviation γ_{n,i,b} among these N NLOS deviations, the calculation formula is: γ_{n,i,b}=ρ_{b,n}−∥\hat{x}_{n,i}−x_{b}∥−\hat{τ}_{n,i}, where \hat{x}_{n,i} and \hat{τ}_{n,i} can be determined by the formula of

$$( {\hat{x}}_{n , i} , {\hat{τ}}_{n , i} ) = arg {max}_{x , τ} p ( {ρ}_{i , 1} \vert {x}_{i} , τ ) ,$$

where n=1 to N.
3. Calculating the mean of the NLOS deviations for the second network device b in the i-th iteration based on the N NLOS deviations for the second network device b in the i-th iteration. That is: [γ_{1,i,b}, . . . , γ_{N,i,b}]→μ_{i,b}.

The program code corresponding to this MLE positioning method can be represented as follows:

```
Initialize parameter vectors x₀, μ₀ and
For i = 0 to I, number of iterations
Collect N pseudo range measurements
ρ_{i,1}, ... , ρ_{i,N}
For b = 1 to B, number of bases
For n = 1 to N, number of measurements
    $( {\hat{x}}_{n , i} , {\hat{τ}}_{n , i} ) = arg {max}_{x , τ} p ( {ρ}_{i , 1} \vert {x}_{i} , τ )$
      γ_{n,i,b} = ρ_{b,n} − ||\hat{x}_{n,i} − x_{b}|| − \hat{τ}_{n,i}
End n
        [γ_{n,i,b}, ... , γ_{N,i,b}] → μ_{i,b}
End b
End i
```

The above provides a detailed description of the method embodiments of the present application with reference to FIGS. 1 to 4. The following will describe the device embodiments of this application with reference to FIGS. 5 to 7. It should be understood that the descriptions of the method embodiments and the device embodiments correspond to each other. Therefore, for portions not described in detail, reference may be made to the preceding method embodiments.

As shown in FIG. 5, the embodiment of this application provides a terminal device 500. The terminal device 500 may include a transmission unit 510.

The transmission unit 510 is configured to transmit first information to a first network device, where the first information indicates a Non-Line-of-Sight (NLOS) channel deviation at the location of the terminal device.

In some embodiments, the first information is carried in a Line-of-Sight (LOS) indication or an NLOS indication.

In some embodiments, the first information indicates a mean and/or a variance of the NLOS channel deviation.

In some embodiments, the first information is determined based on one or more of the following: a pseudorange between the terminal device and a second network device; an estimated position of the terminal device; or an estimated clock error of the terminal device.

In some embodiments, the estimated position of the terminal device and/or the estimated clock error of the terminal device are determined using a maximum likelihood estimation algorithm based on the pseudorange between the terminal device and the second network device.

In some embodiments, the estimated position of the terminal device and the estimated clock error of the terminal device are calculated using the following formula

$${( \hat{x} , \hat{τ} )}_{MLE} = arg {max}_{x , τ} p ( ρ \vert x , τ ) ,$$

where ρ denotes the pseudorange between the terminal device and the second network device, \hat{x} denotes the estimated position of the terminal device, \hat{τ} denotes the estimated clock error of the terminal device, x denotes position coordinates of the terminal device to be solved, τ denotes a clock error of the terminal device to be solved.

In some embodiments, a quantity of the second network device is B, and the pseudorange between the terminal device and the second network device includes pseudoranges between the terminal device and respective ones of the B second network devices. The first information includes means of NLOS channel deviations for the respective ones of the B second network devices.

In some embodiments, a NLOS channel deviation γ_{b} for a second network device b among the B second network devices is calculated using the following formula: γ_{b}=ρ_{b}−∥\hat{x}−x_{b}∥−\hat{τ}, where ρ_{b} denotes the pseudorange between the second network device b and the terminal device, x_{b} denotes a position of the second network device b, the second network device b is one of the B second network devices and b∈{1, . . . , B}.

In some embodiments, a plurality of values of γ_{b} are used to update a mean μ_{b} and/or a variance

$${\tilde{σ}}_{b}^{2}$$

of the NLOS channel deviation for the second network device b by applying a Gaussian Mixture Model.

In some embodiments, a formula for calculating the estimated position of the terminal device and the estimated clock error of the terminal device is determined based on the means of the NLOS channel deviations for the respective ones of the B second network devices, an expanded solution formula of

$${( \hat{x} , \hat{τ} )}_{MLE} = arg {max}_{x , τ} p ( ρ \vert x , τ )$$

is as follows:

$$( \hat{x} , \hat{τ} ) = arg {max}_{x , τ} {\prod }_{b = 1}^{B} \frac{1}{\sqrt{2 {πσ}_{b}^{′2}}} exp [ \frac{- 1}{2 {σ}_{b}^{′2}} {( {ρ}_{b} - ‖ x - {x}_{b} ‖ - τ - {μ}_{b} )}^{2} ] ,$$

$$where {σ}_{b}^{′ 2} = {\tilde{σ}}_{b}^{2} + {σ}_{b}^{2} , and {σ}_{b}^{2}$$

denotes a variance of a random variable.

In some embodiments, the expanded solution formula of

$${( \hat{x} , \hat{τ} )}_{MLE} = arg {max}_{x , τ} p ( ρ \vert x , τ )$$

is derived based on: a conditional likelihood function of ρ_{b} and a Gaussian probability distribution of γ_{b} where the conditional likelihood function of ρ_{b} is

$$p ( {ρ}_{b} \vert x , τ , {γ}_{b} ) = \frac{1}{\sqrt{2 π} {σ}_{b}} exp [ \frac{- 1}{2 {σ}_{b}^{2}} {( {ρ}_{b} - ‖ x - {x}_{b} ‖ - τ - {γ}_{b} )}^{2} ] ,$$

the Gaussian probability distribution of γ_{b} is:

$$p ( {γ}_{b} ) = \frac{1}{{\tilde{σ}}_{b} \sqrt{2 π}} exp [ \frac{- 1}{2 {\tilde{σ}}_{b}^{2}} {( {γ}_{b} - {μ}_{b} )}^{2} ] .$$

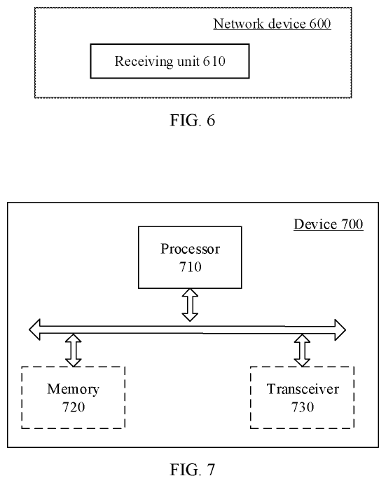

As shown in FIG. 6, the embodiment of this application provides a network device 600. The network device 600 may be the first network device described in previous sections. The network device 600 may include a receiving unit 610.

The receiving unit 610 is configured to receive first information transmitted by a terminal device, where the first information indicates a Non-Line-of-Sight (NLOS) channel deviation at a location of the terminal device.

In some embodiments, the first information is carried in a Line-of-Sight (LOS) indication or an NLOS indication.

In some embodiments, the first information indicates a mean and/or a variance of the NLOS channel deviation.

In some embodiments, the first information is determined based on one or more of the following: a pseudorange between the terminal device and a second network device; an estimated position of the terminal device; or an estimated clock error of the terminal device.

In some embodiments, the estimated position of the terminal device and/or the estimated clock error of the terminal device are determined using a maximum likelihood estimation algorithm based on the pseudorange between the terminal device and the second network device.

In some embodiments, the estimated position of the terminal device and the estimated clock error of the terminal device are calculated using the following formula:

$${( \hat{x} , \hat{τ} )}_{MLE} = arg {max}_{x , τ} p ( ρ \vert x , τ ) ,$$

where ρ denotes the pseudorange between the terminal device and the second network device, \hat{x} denotes the estimated position of the terminal device, \hat{τ} denotes the estimated clock error of the terminal device, x denotes position coordinates of the terminal device to be solved, τ denotes a clock error of the terminal device to be solved.

In some embodiments, a quantity of the second network device is B, the pseudorange between the terminal device and the second network device includes pseudoranges between the terminal device and respective ones of the B second network devices. The first information includes means of NLOS channel deviations for the respective ones of the B second network devices.

In some embodiments, a NLOS channel deviation γ_{b} for a second network device b among the B second network devices is calculated using the following formula: γ_{b}=ρ_{b}−∥\hat{x}−x_{b}∥−\hat{τ}, where ρ_{b} denotes the pseudorange between the second network device b and the terminal device, x_{b} denotes a position of the second network device b, the second network device b is one of the B second network devices and b∈{1, . . . , B}.

In some embodiments, a plurality of values of γ_{b} are used to update a mean μ_{b} and/or a variance

$${\tilde{σ}}_{b}^{2}$$

of the NLOS channel deviation for the second network device b by applying a Gaussian Mixture Model.

In some embodiments, a formula for calculating the estimated position of the terminal device and the estimated clock error of the terminal device is determined based on the means of the NLOS channel deviations for the respective ones of the B second network devices, an expanded solution formula of

$${( \hat{x} , \hat{τ} )}_{MLE} = arg {max}_{x , τ} p ( ρ \vert x , τ )$$

is as follows:

$$( \hat{x} , \hat{τ} ) = arg {max}_{x , τ} {\prod }_{b = 1}^{B} \frac{1}{\sqrt{2 {πσ}_{b}^{′2}}} exp [ \frac{- 1}{2 {σ}_{b}^{′2}} {( {ρ}_{b} - ‖ x - {x}_{b} ‖ - τ - {μ}_{b} )}^{2} ] , where {σ}_{b}^{′2} = {\tilde{σ}}_{b}^{2} + {σ}_{b}^{2} , and {σ}_{b}^{2}$$

denotes a variance of a random variable.

In some embodiments, the expanded solution formula of

$${( \hat{x} , \hat{τ} )}_{MLE} = arg {max}_{x , τ} p ( ρ \vert x , τ )$$

is derived based on a conditional likelihood function of ρ_{b} and a Gaussian probability distribution of γ_{b}, where the conditional likelihood function of ρ_{b} is:

$$p ( {ρ}_{b} \vert x , τ , {γ}_{b} ) = \frac{1}{\sqrt{2 π} {σ}_{b}} exp [ \frac{- 1}{2 {σ}_{b}^{2}} {( {ρ}_{b} - ‖ x - {x}_{b} ‖ - τ - {γ}_{b} )}^{2} ] ,$$

the Gaussian probability distribution of γ_{b} is:

$$p ( {γ}_{b} ) = \frac{1}{{\tilde{σ}}_{b} \sqrt{2 π}} exp [ \frac{- 1}{2 {\tilde{σ}}_{b}^{2}} {( {γ}_{b} - {μ}_{b} )}^{2} ] .$$

FIG. 7 is a schematic structural diagram of a device according to an embodiment of this application. The device 700 may be a device for positioning. The dashed lines in FIG. 7 indicate that the unit or the module is optional. The device 700 may be configured to perform the method described in the foregoing method embodiments. The device 700 may be a chip, a terminal device, or a network device.

The device 700 may include one or more processors 710. The processor 710 may support the device 700 in performing the method described in the foregoing method embodiments. The processor 710 may be a general-purpose processor or a dedicated processor. For example, the processor may be a central processing unit (CPU). Alternatively, the processor may be another general-purpose processor, a digital signal processor (DSP), an application specific integrated circuit (ASIC), a field programmable gate array (FPGA) or another programmable logic device, a discrete gate or a transistor logic device, or a discrete hardware component or the like. The general-purpose processor may be a microprocessor, or the processor may be any conventional processor or the like.

The device 700 may further include one or more memories 720. A program is stored in the memory 720, and the program may be executed by the processor 710, so that the processor 710 performs the method described in the foregoing method embodiments. The memory 720 may be independent of the processor 710 or may be integrated into the processor 710.

The device 700 may further include a transceiver 730. The processor 710 may communicate with another device or chip by using the transceiver 730. For example, the processor 710 may transmit or receive data to or from another device or chip by using the transceiver 730.

An embodiment of this application further provides a computer-readable storage medium, configured to store a program. The computer-readable storage medium may be applied to the terminal or the network device provided in the embodiments of this application, and the program enables a computer to perform the method performed by the terminal or the network device in the various embodiments of this application.

An embodiment of this application further provides a computer program product. The computer program product includes a program. The computer program product may be applied to the terminal or the network device provided in the embodiments of this application, and the program enables a computer to perform the method performed by the terminal or the network device in the various embodiments of this application.

An embodiment of this application further provides a computer program. The computer program may be applied to the terminal or the network device provided in the embodiments of this application, and the computer program enables a computer to perform the method performed by the terminal or the network device in the various embodiments of this application.

It should be understood that the terms “system” and “network” in this application may be used interchangeably. In addition, the terms used in this application are merely used to explain specific embodiments of this application, but are not intended to limit this application. The terms “first”, “second”, “third”, “fourth”, and the like in the specification, claims, and accompanying drawings of this application are used to distinguish between different objects, but are not used to describe a specific sequence. In addition, the terms “include”, “have”, and any variants thereof are intended to cover non-exclusive inclusion.

In the embodiments of this application, the mentioned “indication” may be a direct indication, may be an indirect indication, or may indicate that there is an association relationship. For example, A indicates B, which may indicate that A directly indicates B, for example, B may be obtained through A; or may indicate that A indirectly indicates B, for example, A indicates C, and B may be obtained through C; or may indicate that there is an association relationship between A and B.

In the embodiments of this application, “B corresponding to A” indicates that B is associated with A, and B may be determined based on A. However, it should be further understood that determining B based on A does not mean that B is determined based on A only, and B may alternatively be determined based on A and/or other information.

In the embodiments of this application, the term “correspond” may indicate that there is a direct correspondence or indirect correspondence between the two, or may indicate that there is an association relationship between the two, or may indicate an relationship of indicating and being indicated, configurating and being configured, or the like.

In the embodiments of this application, “predefined” or “preconfigured” may be implemented by pre-storing corresponding code, a table, or another manner that can be used to indicate related information in a device (for example, including a terminal device and a network device). This application is not limited to a specific implementation thereof. For example, “predefined” may mean being defined in a protocol.

In the embodiments of this application, the “protocol” may be a standard protocol in the communications field, for example, may include an LTE protocol, an NR protocol, and a related protocol applied to a future communications system. This is not limited in this application.

In the embodiments of this application, the term “and/or” describes only an association relationship between associated objects and represents that three cases may exist. For example, A and/or B may represent the following three cases: Only A exists, both A and B exist, and only B exists. In addition, the character “/” in this specification generally indicates an “or” relationship between the associated objects.

In the embodiments of this application, the “include” may mean directly including, or may mean indirectly including. Optionally, the “include” mentioned in the embodiments of this application may be replaced with “indicate” or “used to determine”. For example, A includes B may be replaced with A indicates B, or A is used to determine B.

In the various embodiments of this application, a sequence number of each process does not mean an execution sequence. The execution sequence of each process should be determined according to a function and an internal logic of the process, and should not constitute any limitation on an implementation process of the embodiments of this application.

In the several embodiments provided in this application, it should be understood that the disclosed system, device, and method may be implemented in other manners. For example, the described device embodiments are merely examples. For example, division into the units is merely logical function division and may be other division in actual implementation. For example, a plurality of units or components may be combined or integrated into another system, or some features may be ignored or not performed. In addition, the displayed or discussed mutual couplings or direct couplings or communication connections may be implemented as indirect couplings or communication connections through some interfaces, devices or units, and may be implemented in electrical, mechanical, or other forms.

The units described as separate parts may or may not be physically separate, and parts displayed as units may or may not be physical units, may be located in one position, or may be distributed on a plurality of network units. Some or all of the units may be selected based on actual requirements to achieve the objectives of the solutions of the embodiments.

In addition, functional units in the embodiments of this application may be integrated into one processing unit, or each of the units may exist alone physically, or two or more units are integrated into one unit.

In the foregoing embodiments, the embodiments may be implemented completely or partially by software, hardware, firmware, or any combination thereof. When software is used for implementation, the embodiments may be implemented completely or partially in a form of a computer program product. The computer program product includes one or more computer instructions. When the computer program instructions are loaded and executed on a computer, the procedures or functions according to the embodiments of this application are all or partially implemented. The computer may be a general-purpose computer, a dedicated computer, a computer network, or another programmable device. The computer instructions may be stored in a computer-readable storage medium, or may be transmitted from one computer-readable storage medium to another computer-readable storage medium. For example, the computer instructions may be transmitted from a website, a computer, a server, or a data center to another website, computer, server, or data center in a wired (for example, a coaxial cable, an optical fiber, or a digital subscriber line (DSL)) or wireless (for example, infrared, radio, or microwave) manner. The computer-readable storage medium may be any usable medium accessible by a computer, or a data storage device, such as a server or a data center, integrating one or more usable media. The usable medium may be a magnetic medium (for example, a floppy disk, a hard disk, or a magnetic tape), an optical medium (for example, a digital video disc (DVD)), a semiconductor medium (for example, a solid state disk (SSD)), or the like.

The foregoing descriptions are merely specific implementations of this application, but the protection scope of this application is not limited thereto. Any variation or replacement readily conceived out by a person skilled in the art within the technical scope disclosed in this application shall fall within the protection scope of this application. Therefore, the protection scope of this application shall be subject to the protection scope of the claims.

What is claimed is:

1. A positioning method, comprising:
transmitting, by a terminal device, first information to a first network device, wherein the first information indicates a Non-Line-of-Sight (NLOS) channel deviation at a location of the terminal device.

2. The method according to claim 1, wherein the first information is carried in a Line-of-Sight (LOS) indication or an NLOS indication.

3. The method according to claim 1, wherein the first information indicates a mean and/or a variance of the NLOS channel deviation.

4. The method according to claim 1, wherein the first information is determined based on one or more of the following: a pseudorange between the terminal device and a second network device; an estimated position of the terminal device; or an estimated clock error of the terminal device.

5. The method according to claim 4, wherein the estimated position of the terminal device and/or the estimated clock error of the terminal device are determined using a maximum likelihood estimation algorithm based on the pseudorange between the terminal device and the second network device.

6. The method according to claim 5, wherein the estimated position of the terminal device and the estimated clock error of the terminal device are calculated using the following formula:
$${( \hat{x} , \hat{τ} )}_{MLE} = arg {max}_{x , τ} p ( ρ \vert x , τ ) ,$$
wherein ρ denotes the pseudorange between the terminal device and the second network device, \hat{x} denotes the estimated position of the terminal device, \hat{τ} denotes the estimated clock error of the terminal device, x denotes position coordinates of the terminal device to be solved, τ denotes a clock error of the terminal device to be solved.

7. The method according to claim 4, wherein a quantity of the second network device is B, and the pseudorange between the terminal device and the second network device comprises pseudoranges between the terminal device and respective ones of the B second network devices, and the first information comprises means of NLOS channel deviations for the respective ones of the B second network devices.

8. The method according to claim 7, wherein a NLOS channel deviation γ_{b} for a second network device b among the B second network devices is calculated using the following formula:
$${γ}_{b} = {ρ}_{b} - ‖ \hat{x} - {x}_{b} ‖ - \hat{τ} ,$$
where ρ_{b} denotes the pseudorange between the second network device b and the terminal device, x_{b} denotes a position of the second network device b, the second network device b is one of the B second network devices and b∈{1, . . . , B}.

9. The method according to claim 8, wherein a plurality of values of γ_{b} are used to update a mean μ_{b} and/or a variance
$${\tilde{σ}}_{b}^{2}$$
of the NLOS channel deviation for the second network device b by applying a Gaussian Mixture Model.

10. The method according to claim 9, wherein a formula for calculating the estimated position of the terminal device and the estimated clock error of the terminal device is determined based on the means of the NLOS channel deviations for the respective ones of the B second network devices, an expanded solution formula of
$${( \hat{x} , \hat{τ} )}_{MLE} = arg {max}_{x , τ} p ( ρ \vert x , τ )$$
is as follows:
$$( \hat{x} , \hat{τ} ) = arg {max}_{x , τ} {\prod }_{b = 1}^{B} \frac{1}{\sqrt{2 {πσ}_{b}^{′2}}} exp [ \frac{- 1}{2 {σ}_{b}^{′2}} {( {ρ}_{b} - ‖ x - {x}_{b} ‖ - τ - {μ}_{b} )}^{2} ] , where {σ}_{b}^{′2} = {\tilde{σ}}_{b}^{2} + {σ}_{b}^{2} , {σ}_{b}^{2}$$
denotes a variance of a random variable.

11. The method according to claim 10, wherein the expanded solution formula of
$${( \hat{x} , \hat{τ} )}_{MLE} = arg {max}_{x , τ} p ( ρ \vert x , τ )$$
is derived based on a conditional likelihood function of ρ_{b} and a Gaussian probability distribution of γ_{b}, where the conditional likelihood function of ρ_{b} is:
$$p ( {ρ}_{b} \vert x , τ , {γ}_{b} ) = \frac{1}{\sqrt{2 π} {σ}_{b}} exp [ \frac{- 1}{2 {σ}_{b}^{2}} {( {ρ}_{b} - ‖ x - {x}_{b} ‖ - τ - {γ}_{b} )}^{2} ] ,$$
the Gaussian probability distribution of γ_{b} is:
$$p ( {γ}_{b} ) = \frac{1}{{\tilde{σ}}_{b} \sqrt{2 π}} exp [ \frac{- 1}{2 {\tilde{σ}}_{b}^{2}} {( {γ}_{b} - {μ}_{b} )}^{2} ] .$$

12. A positioning method, comprising:
receiving, by a first network device, first information transmitted by a terminal device, wherein the first information indicates a Non-Line-of-Sight (NLOS) channel deviation at the location of the terminal device.

13. The method according to claim 12, wherein the first information is carried in a Line-of-Sight (LOS) indication or an NLOS indication.

14. The method according to claim 12, wherein the first information indicates a mean and/or a variance of the NLOS channel deviation.

15. The method according to claim 12, wherein the first information is determined based on one or more of the following: a pseudorange between the terminal device and a second network device; an estimated position of the terminal device; or an estimated clock error of the terminal device.

16. The method according to claim 15, wherein the estimated position of the terminal device and/or the estimated clock error of the terminal device are determined using a maximum likelihood estimation algorithm based on the pseudorange between the terminal device and the second network device.

17. The method according to claim 16, wherein the estimated position of the terminal device and the estimated clock error of the terminal device are calculated using the following formula:
$${( \hat{x} , \hat{τ} )}_{MLE} = arg {max}_{x , τ} p ( ρ \vert x , τ ) ,$$
where ρ denotes the pseudorange between the terminal device and the second network device, \hat{x} denotes the estimated position of the terminal device, \hat{τ} denotes the estimated clock error of the terminal device, x denotes position coordinates of the terminal device to be solved, τ denotes a clock error of the terminal device to be solved.

18. The method according to claim 15, wherein a quantity of the second network device is B, the pseudorange between the terminal device and the second network device comprises pseudoranges between the terminal device and respective ones of the B second network devices, and the first information comprises means of NLOS channel deviations for the respective ones of the B second network devices.

19. A terminal device, comprising a processor configured to:
transmit first information to a first network device, wherein the first information indicates a Non-Line-of-Sight (NLOS) channel deviation at a location of the terminal device.

20. A network device, wherein the network device is a first network device, and the network device comprises a processor configured to perform the method according to claim 12.
